(19) United States
(12) Patent Application Publication
(10) Pub. No.: US 2022/0312437 A1
(43) Pub. Date: Sep. 29, 2022

(54) SCHEDULING REQUEST PRIORITIZATION

(71) Applicant: TELEFONAKTIEBOLAGET LM ERICSSON (PUBL), STOCKHOLM (SE)

(72) Inventors: Ali Behravan, STOCKHOLM (SE); Jonas Fröberg Olsson, LJUNGSBRO (SE); Mattias Andersson, SUNDBYBERG (SE); Kittipong Kittichokechai, JÄRFÄLLA (SE); Zhenhua Zou, SOLNA (SE); Yufei Blankenship, KILDEER, IL (US)

(21) Appl. No.: 17/619,152

(22) PCT Filed: May 28, 2020
(86) PCT No.: PCT/IB2020/055093

§ 371 Date: Dec. 14, 2021

Related U.S. Application Data
(60) Provisional application No. 62/861,869, filed on Jun. 14, 2019.

(51) Int. Cl. H04W 72/12

(52) U.S. Cl. CPC H04W 72/1242; H04W 72/1284

(57) ABSTRACT

Systems and methods for scheduling request (SR) prioritization are disclosed herein. In one embodiment, a method performed by a wireless device for prioritized SR transmission comprises transmitting, to a base station, a SR for data generated on a particular logical channel on a Physical Uplink Control Channel (PUCCH) resource in accordance with an associated SR configuration, wherein a SR priority of the SR is indicated by one or more physical layer properties of the PUCCH resource, in accordance with a mapping between the one or more physical layer properties of the PUCCH and the SR priority.

### RELATED APPLICATIONS

This application claims the benefit of U.S. Provisional Patent Application No. 62/861,869, filed Jun. 14, 2019, the disclosure of which is hereby incorporated herein by reference in its entirety.

### TECHNICAL FIELD

The present disclosure relates to prioritizing scheduling requests in a radio access network of a cellular communications system.

### BACKGROUND

The New Radio (NR) standard in Third Generation Partnership Project (3GPP) is designed to provide service for multiple use cases such as enhanced Mobile Broadband (eMBB), Ultra-Reliable and Low Latency Communication (URLLC), and Machine Type Communication (MTC). Each of these services has different technical requirements. For example, the general requirement for eMBB is high data rate with moderate latency and moderate coverage, while URLLC service requires a low latency and high reliability transmission but perhaps for moderate data rates.

One of the solutions for low latency data transmission is shorter transmission time intervals. In NR in addition to transmission in a slot, a mini-slot transmission is also allowed to reduce latency. A mini-slot is a concept that is used in scheduling. Currently, in downlink (DL), a min-slot can consist of 2, 4, or 7 Orthogonal Frequency Division Multiplexing (OFDM) symbols, while in uplink (UL) a mini-slot can be any number of 1 to 14 OFDM symbols. It should be noted that the concepts of slot and mini-slot are not specific to a specific service meaning that a mini-slot may be used for either eMBB, URLLC, or other services. FIG. 1 illustrates an exemplary radio resource in NR with subcarrier spacing of 15 kilohertz (kHz).

A Scheduling Request (SR) is sent on a Physical Uplink Control Channel (PUCCH) by a User Equipment (UE) to request a grant for UL transmission, when the UE has data to transmit but does not already have a grant. The SR is sent on preconfigured and periodically occurring PUCCH dedicated to the UE.

The procedure for sending a SR is that, when data is generated on a higher layer by a logical channel, a SR is triggered with an associated SR configuration. Each SR configuration corresponds to one or more logical channels, and each logical channel may be mapped to zero or one SR configuration, which is configured by Radio Resource Control (RRC).

The RRC configuration for logical channel configuration as described in 3GPP Technical Specification (TS) 38.331 V15.5.1 is shown in FIG. 20. The RRC configuration has a field for a scheduling request identifier (ID). The RRC configuration for SR resource configuration, which maps scheduling request ID to SR resource configuration, as described in 3GPP Technical Specification (TS) 38.331 V15.5.1 is shown in FIG. 21.

FIG. 2 can be used to illustrate the relation between logical channels, SR IDs, SR configurations, and PUCCH resources for a single Bandwidth Part (BWP). In this example, the number of logical channels is 8 and the number of SR IDs is 4. FIG. 2 is for illustration purpose only. In NR Rd-15, there can be a maximum of 32 logical channels, and 8 SR IDs.

### SUMMARY

Systems and methods for scheduling request (SR) prioritization are disclosed herein. In one embodiment, a method performed by a wireless device for prioritized SR transmission comprises receiving a SR resource configuration from a base station, wherein the SR resource configuration comprises an indication of a SR priority. The method further comprises transmitting, to a base station, a SR for data generated on a particular logical channel on a Physical Uplink Control Channel (PUCCH) resource in accordance with the SR configuration, wherein a SR priority of the SR is the SR priority indicated in the SR resource configuration. In this manner, the priority of SR request is identified based on the physical layer properties of the signal.

In another embodiment, a method performed by a wireless device for prioritized SR, transmission comprises transmitting, to a base station, a SR for data generated on a particular logical channel on a PUCCH resource in accordance with an associated SR configuration, wherein a SR priority of the SR is indicated by one or more physical layer properties of the PUCCH resource, in accordance with a mapping between the one or more physical layer properties of the PUCCH and the SR priority.

In one embodiment, the mapping is a mapping between the associated SR resource configuration and the SR priority. In one embodiment, the method further comprises receiving the associated SR resource configuration from the base station, wherein the associated SR resource configuration comprises an indication of the SR priority.

In one embodiment, the mapping is a mapping between the particular logical channel and the SR priority. In another embodiment, the mapping is a mapping between a group of logical channels comprising the particular logical channel and the SR priority. In another embodiment, the mapping is based on one or more configurable thresholds for one or more properties of the particular logical channel. In another embodiment, the mapping is a mapping between an SR identity mapped to the associated SR resource configuration and the SR priority. In another embodiment, the mapping is a mapping between a group of SR identities comprising an SR identity mapped to the associated SR resource configuration and the SR priority. In another embodiment, the mapping is a mapping between the PUCCH resource and the SR priority. In another embodiment, the associated SR resource configuration comprises a field that indicates the PUCCH resource, and the SR priority is determined by a priority associated with the PUCCH resource.

In one embodiment, the method further comprises receiving, from the base station, information that provides the mapping between the one or more physical layer properties of the

PUCCH resource and the SR priority. In one embodiment, receiving the information comprises receiving the information via Radio Resource Control (RRC) signaling.

Corresponding embodiments of a wireless device are also disclosed. In one embodiment, a wireless device for prioritized SR transmission is adapted to transmit, to a base station, a SR for data generated on a particular logical channel on a PUCCH resource in accordance with an associated SR configuration, herein a SR priority of the SR is indicated by one or more physical layer properties of the PUCCH resource, in accordance with a mapping between the one or more physical layer properties of the PUCCH and the SR priority.

In one embodiment, a wireless device for prioritized SR transmission comprises one or more transmitters and processing circuitry associated with the one or more transmitters. The processing circuitry is configured to cause the wireless device to transmit, to a base station, a SR for data generated on a particular logical channel on a PUCCH resource in accordance with an associated SR configuration, wherein a SR priority of the SR is indicated by one or more physical layer properties of the PUCCH resource, in accordance with a mapping between the one or more physical layer properties of the PUCCH and the SR priority.

Embodiments of a method performed by a base station for SR prioritization are also disclosed. In one embodiment, a method performed by a base station for SR prioritization comprises receiving, from a wireless device, a SR for data generated on a particular logical channel on a PUCCH resource in accordance with an associated SR configuration and determining a SR priority of the SR based on a mapping between one or more physical layer properties of the PUCCH and the SR priority.

In one embodiment, the mapping is a mapping between the associated SR resource configuration and the SR priority.

In one embodiment, the method further comprises transmitting, to the wireless device, the SR resource configuration, wherein the SR resource configuration comprises an indication of the SR priority.

In one embodiment, the mapping is a mapping between the particular logical channel and the SR priority. In another embodiment, the mapping is a mapping between a group of logical channels comprising the particular logical channel and the SR priority. In another embodiment, the mapping is based on one or more configurable thresholds for one or more properties of the particular logical channel. In another embodiment, the mapping is a mapping between an SR identity mapped to the associated SR resource configuration and the SR priority. In another embodiment, the mapping is a mapping between a group of SR identities comprising an SR identity mapped to the associated SR resource configuration and the SR priority. In another embodiment, the mapping is a mapping between the PUCCH resource and the SR priority.

In one embodiment, the method further comprises transmitting, to the wireless device, information that provides the mapping between the one or more physical layer properties of the PUCCH resource and the SR priority. In one embodiment, transmitting the information comprises transmitting the information via RRC signaling.

In one embodiment, the method further comprises processing the SR in accordance with the determined SR priority.

In one embodiment, the mapping maps the one or more physical layer properties of the PUCCH resource to two or more SR priorities, and determining the SR priority of the SR based on the mapping comprises selecting one of the two or more SR priorities as the SR priority of the SR. In one embodiment, selecting one of the two or more SR priorities as the SR priority of the SR comprises selecting a highest SR priority from among the two or more SR priorities as the SR priority of the SR. In one embodiment, selecting one of the two or more SR priorities as the SR priority of the SR comprises selecting a lowest SR priority from among the two or more SR priorities as the SR priority of the SR.

Corresponding embodiments of a base station are also disclosed. In one embodiment, a base station for SR prioritization is adapted to receive, from a wireless device, a SR for data generated on a particular logical channel on a PUCCH resource in accordance with an associated SR configuration and determine a SR priority of the SR based on a mapping between one or more physical layer properties of the PUCCH and the SR priority.

In one embodiment, a base station for SR prioritization comprises processing circuitry configured to cause the base station to receive, from a wireless device, a SR for data generated on a particular logical channel on a PUCCH resource in accordance with an associated SR configuration and determine a SR priority of the SR based on a mapping between one or more physical layer properties of the PUCCH and the SR priority.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates an exemplary radio resource in New Radio (NR) with subcarrier spacing of 15 kilohertz (kHz);

FIG. 2 illustrates the conventional relation between logical channels, Scheduling Request (SR) Identifiers (IDs), SR configurations, and Physical Uplink Control Channel (PUCCH) resources for a single Bandwidth Part (BWP);

FIG. 3 illustrates one example of a cellular communications system in which embodiments of the present disclosure may be implemented;

FIG. 4 illustrates an example of mapping logical channels to SR priorities and tracing back from a PUCCH resource to the respective logical channel(s) and associated SR priority in accordance with an embodiment of the present disclosure;

FIG. 5 shows the example of a scenario in which a PUCCH resource maps to multiple SR priorities;

FIG. 6 shows the example of a scenario in which a PUCCH resource is associated to multiple SR configurations and thus may map to multiple SR priorities;

FIG. 7 shows an example of SR priority ambiguity when an SR priority field is included in the SR configuration;

FIG. 8 illustrates the operation of a base station (e.g., a gNB) and a wireless device (e.g., a UE) in accordance with at least some of aspects of the embodiments of the present disclosure;

FIGS. 9, 10, and 11 are schematic block diagrams of or including a radio access node (e.g., a base station) in accordance with embodiments of the present disclosure;

FIGS. 12 and 13 are schematic block diagrams of a wireless device (e.g., a UE) in accordance with embodiments of the present disclosure;

FIG. 14 illustrates an example embodiment of a communication system in which embodiments of the present disclosure may be implemented;

FIG. 15 illustrates example embodiments of the host computer, base station, and UE of FIG. 14;

FIGS. 16, 17, 18, and 19 are flow charts that illustrate example embodiments of methods implemented in a communication system such as that of FIG. 14;

FIG. 20 illustrates the conventional LogicalChannelConfig information element defined in Third Generation Partnership Project (3GPP) Technical Specification (TS) 38.331 V15.5.1; and

FIG. 21 illustrates the conventional SchedulingRequestResourceConfig information element defined in 3GPP TS 38.331 V15.5.1.

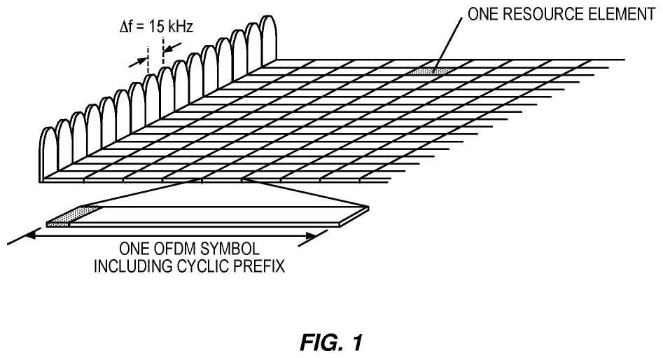

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Radio Node: As used herein, a “radio node” is either a radio access node or a wireless device.

Radio Access Node: As used herein, a “radio access node” or “radio network node” is any node in a radio access network of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), and a relay node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing a Access and Mobility Function (AMF), a UPF, a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Wireless Device: As used herein, a “wireless device” is any type of device that has access to (i.e., is served by) a cellular communications network by wirelessly transmitting and/or receiving signals to a radio access node(s). Some examples of a wireless device include, but are not limited to, a User Equipment device (UE) in a 3GPP network and a Machine Type Communication (MTC) device.

Network Node: As used herein, a “network node” is any node that is either part of the radio access network or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

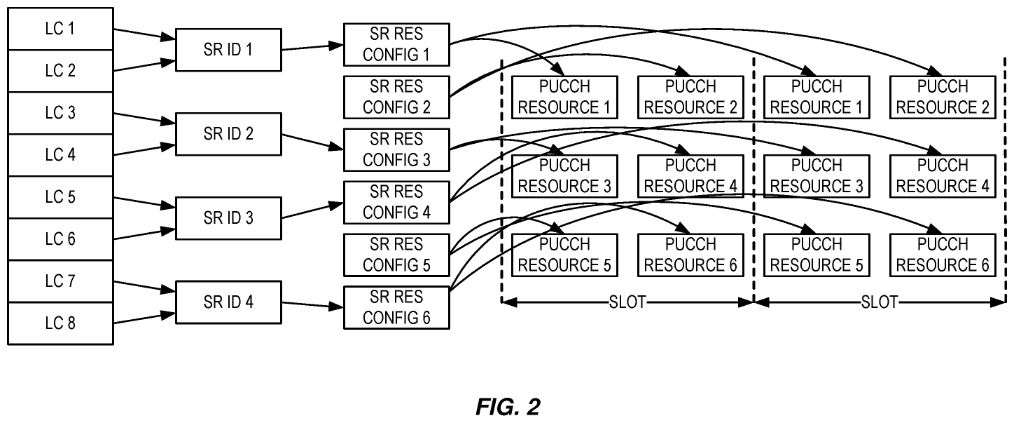

There currently exist certain challenge(s). In Ultra-Reliable Low-Latency Communication (URLLC), where data with different priorities (i.e. different latency and/or reliability) should be handled, it is useful to know the priority of the data when a Scheduling Request (SR) is received by the NR base station (gNB). This can be useful in resolving conflicts between different types of control signaling on the physical layer. However the current design for the relation between logical channels, SR identifiers (IDs), SR configurations, and Physical Uplink Control Channel (PUCCH) resources, as shown in FIG. 2, does not contain any information of the SR priority in the physical layer, and physical layer properties of the PUCCH have no relation to the SR priority.

Certain aspects of the present disclosure and their embodiments may provide solutions to the aforementioned or other challenges. Systems and methods are disclosed herein for mapping the priority of a SR (referred to herein as a “SR priority”) to physical layer properties of the PUCCH that is used to carry the SR. Embodiments of the present disclosure include, e.g.:
systems and methods for mapping between SR priority and the SR resource configuration;
systems and methods for determining SR priority from priority associated with a PUCCH resource; and
systems and methods for resolving ambiguity in determining SR priority.

Certain embodiments may provide one or more of the following technical advantage(s). For example, embodiments of the present disclosure provide a solution to identify the priority of SR request based on the physical layer properties of the signal.

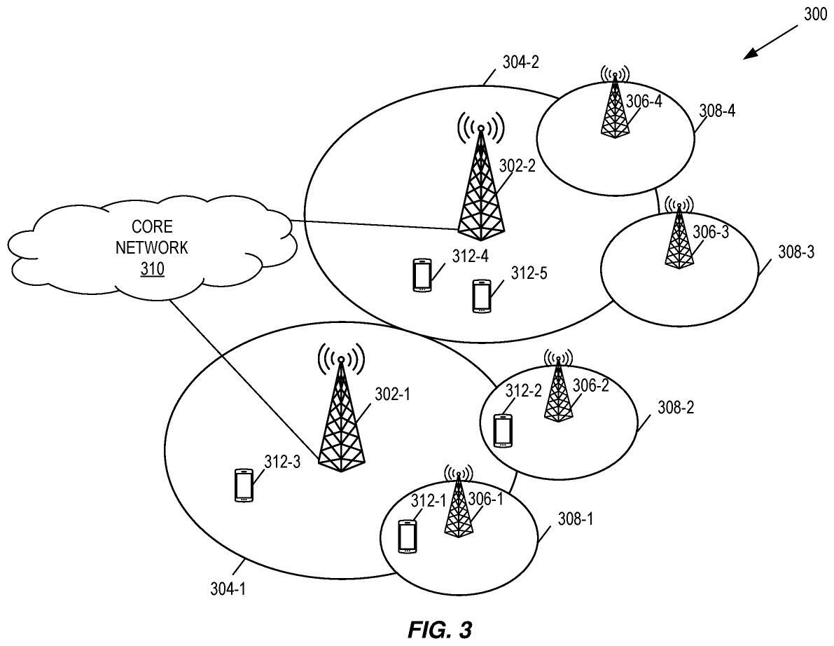

In this regard, FIG. 3 illustrates one example of a cellular communications system 300 in which embodiments of the present disclosure may be implemented. In the embodiments described herein, the cellular communications system 300 is a 5G system (5GS) including a NR RAN. In this example, the RAN includes base stations 302-1 and 302-2, which in 5G NR are referred to as gNBs, controlling corresponding (macro) cells 304-1 and 304-2. The base stations 302-1 and 302-2 are generally referred to herein collectively as base stations 302 and individually as base station 302. Likewise, the (macro) cells 304-1 and 304-2 are generally referred to herein collectively as (macro) cells 304 and individually as (macro) cell 304. The RAN may also include a number of low power nodes 306-1 through 306-4 controlling corresponding small cells 308-1 through 308-4. The low power nodes 306-1 through 306-4 can be small base stations (such as pico or femto base stations) or Remote Radio Heads (RRHs), or the like. Notably, while not illustrated, one or more of the small cells 308-1 through 308-4 may alternatively be provided by the base stations 302. The low power nodes 306-1 through 306-4 are generally referred to herein collectively as low power nodes 306 and individually as low power node 306. Likewise, the small cells 308-1 through 308-4 are generally referred to herein collectively as small cells 308 and individually as small cell 308. The cellular communications system 300 also includes a core network 310, which in the 5GS is referred to as the 5G core (5GC). The base stations 302 (and optionally the low power nodes 306) are connected to the core network 310.

The base stations 302 and the low power nodes 306 provide service to wireless devices 312-1 through 312-5 in the corresponding cells 304 and 308. The wireless devices 312-1 through 312-5 are generally referred to herein collectively as wireless devices 312 and individually as wireless device 312. The wireless devices 312 are also sometimes referred to herein as UEs.

1 Mapping Between SR Priority and SR Resource Configuration

According to some embodiments of the present disclosure, a mapping between SR resource configuration and the SR priorities is established by two steps:

1. mapping the logical channels to different SR priorities, and

2. obtaining SR priority at the physical layer.

Details of the two steps are further explained below.

1.1 Mapping the Logical Channels to Different SR Priorities

In some embodiments, the mapping is between one logical channel and one SR priority. In some other embodiments, logical channels are divided into groups, and each group of logical channels is mapped to one SR priority.

In some embodiments, the mapping is configured by the network (e.g., by RRC) or predefined (e.g., via an appropriate specification).

In some embodiments, the mapping is derived (e.g., by the gNB and the UE). More specifically, in some embodiments, the mapping is based on a configurable threshold for one or more properties of the logical channel. For example, if a property of the logical channel that triggered the SR is below a threshold, then the SR is declared as high priority, or vice versa. In general, if M_{prio,SR} values of Prio_{SR} (SR priorities) are needed, then (M_{prio,SR}−1) thresholds are needed. In one example, the property of the logical channel is its ‘priority’. For both logical channel priority and SR priority, an increasing priority value indicates a lower priority level.
a) For example, if M_{prio,SR}=2 levels of Prio_{SR} are needed, then one threshold of logical channel ‘priority’ is needed. For instance, the logical channel ‘priority’ threshold can be: 8. Thus, SR priority=1 (i.e., higher SR priority) if the corresponding logical channel ‘priority’<=8; otherwise, SR priority=2 (i.e., lower SR priority).
b) For example, if M_{prio,SR}=4 levels of Prio_{SR} are needed, then three thresholds of logical channel ‘priority’ are needed. For instance, the logical channel ‘priority’ thresholds can be: 3, 8, 13. Thus, SR priority=1 (i.e., highest SR priority) if the corresponding logical channel ‘priority’<=3; else SR priority=2 if the corresponding logical channel ‘priority’<=8; else SR priority=3 if the corresponding logical channel ‘priority’<=13; otherwise SR priority=4 (i.e., lowest SR priority).

Alternatively, the mapping between logical channel (hence logical channel priority) and SR priority can be explicitly defined by providing a SR priority field in the SR configuration. This is illustrated below when two SR priority levels are defined.

SchedulingRequestResourceConfig information element

| -- ASN1START | |
|---|---|
| -- TAG-SCHEDULINGREQUESTRESOURCECONFIG-START | |
| SchedulingRequestResourceConfig ::= | SEQUENCE { |
| schedulingRequestResourceId | SchedulingRequestResourceId, |
| schedulingRequestID | SchedulingRequestId, |
| schedulingRequestPriority | INTEGER (1..2), |
| periodicityAndOffset | CHOICE { |
| sym2 | NULL, |
| sym6or7 | NULL, |
| sl1 | NULL, -- Recurs in every |
| slot | |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19), |
| sl40 | INTEGER (0..39), |
| sl80 | INTEGER (0..79), |
| sl160 | INTEGER (0..159), |
| sl320 | INTEGER (0..319), |
| sl640 | INTEGER (0..639) |
| } | |
| OPTIONAL, -- Need M | |
| resource | PUCCH-ResourceId |

OPTIONAL -- Need M
}

The value range (1 . . . 2) show above is for illustration purpose only. In general, when M_{prio,SR} SR priority levels are defined, the value range can be provided correspondingly. For example, the following can be used when M_{prio,SR}=4 SR priority levels are to be defined.
schedulingRequestPriority INTEGER (1 . . . 4),

1.2 Obtain SR Priority at Physical Layer

In some embodiments, the SR priority is used at the physical layer for the prioritization procedure of SR with data and other Uplink Control Information (UCI) including Hybrid Automatic Repeat Request Acknowledgement (HARQ-ACK) and Channel State Information (CSI).

In one embodiment, the SR priority is obtained at the physical layer by tracing back from the SR resource configuration to SR priority, where a SR priority is associated with the logical channel which triggered the SR.

The SR resource configuration contains timing information of SR transmission occasions (i.e., periodicityAndOffset) and the PUCCH resource configuration. In one embodiment, there is clear one-to-one mapping between the SR resource configuration and the SR priority.

As an example for the example of FIG. 2, two SR priorities can be defined, where the mapping of logical channels to SR priorities is:
SR Priority 1={LC1, LC2, LC3, LC4}
SR Priority 2={LC5, LC6, LC7, LC8}

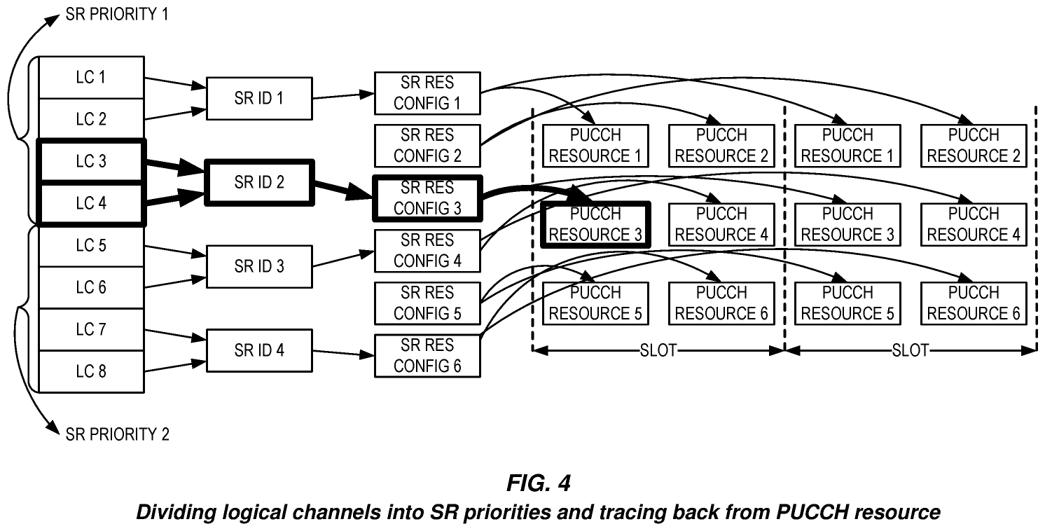

FIG. 4 illustrates an example of mapping logical channels to SR priorities and tracing back from a PUCCH resource to the respective logical channel(s) and associated SR priority. As shown in the FIG. 4, based on the PUCCH resource that is used to send the SR, the gNB can determine the SR priority by tracing back through the SR configuration of the triggered SR, and the logical channels. In this example, the SR request is received on PUCCH resource 3. The gNB can trace back from PUCCH resource 3 to find that either of the LC3 or LC4 triggered the SR, both of which belong to SR priority 1 group.

In another embodiment, when an SR priority field is included in the SR configuration, the SR priority is available at the physical layer by directly checking the RRC configuration of the scheduling request resource (i.e., the SR configuration of the PUCCH resource on which the SR was received). Additionally, it is possible to divide the SR IDs into groups each corresponding to a SR priority. In the example of FIG. 4, the corresponding grouping would be:
SR Priority 1={SR ID1, SR ID2}
SR Priority 2={SR ID3, SR ID4}.

In other example, more than two priorities can be defined using similar mapping methodologies.

In some embodiments, the PUCCH resource is associated with a priority, e.g. according to the highlighted priority field in the PUCCH-Resource IE:

| | |
|---|---|
| PUCCH-Resource ::= | SEQUENCE { |
| pucch-ResourceId | PUCCH-ResourceId, |
| prioriy | INTEGER(1..X) |
| startingPRB | PRB-Id, |
| intraSlotFrequencyHopping | ENUMERATED { enabled |
| } | OPTIONAL, -- Need R |
| secondHopPRB | PRB- |
| Id | OPTIONAL, -- |

Need R

| | |
|---|---|
| format | CHOICE { |
| format0 | PUCCH-format0, |
| format1 | PUCCH-format1, |
| format2 | PUCCH-format2, |
| format3 | PUCCH-format3, |
| format4 | PUCCH-format4 |

}
}

In such embodiments the priority of SR with a SR configuration with “resource” field with value
resource=PUCCH-ResourceX
   is determined by the priority field of PUCCH-ResourceX. In this manner, in one embodiment, the SR priority is defined by a mapping between the SR priority and the PUCCH resource.

PUCCH resource that is associated with a priority can be used to determine prioritizations between scheduling request, HARQ-ACK, or CSI.

2 Resolving Ambiguity in Determining SR Priority

2.1 When SR Priority Field is Not Included in the SR Configuration

Ambiguity may exist when determining SR priority in case the PUCCH resource of a given SR transmission occasion maps to multiple SR priorities. Since the mapping between SR resource configurations and the logical channels is not one-to-one, there might be cases in which one PUCCH resource maps to multiple logical channels at a given SR transmission occasion. In this case, a rule can be defined in the specification or by semi-static configuration, such that the final SR priority at the given SR transmission occasion is equal to the highest among the identified SR priorities. Alternatively, the final SR priority is equal to the lowest among the identified SR priorities.

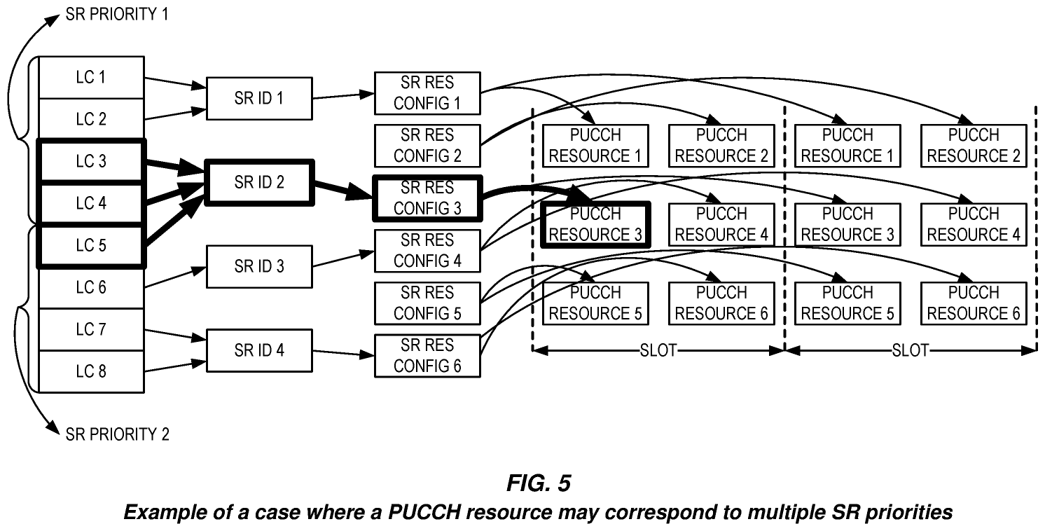

FIG. 5 shows the example where PUCCH resource 3 may correspond to LC3, LC4, or LC5, which means that it could be from either SR priority 1 or SR priority 2. In this case, both the UE and the gNB may assign the SR in the transmission occasion of the bolded PUCCH resource 3 the highest priority among all the associated logical channels, as well as all the associated SR priorities, e.g. SR priority 1, even if the logical channel that triggered the SR is of lower priority (for example, LCHS with SR priority 2).

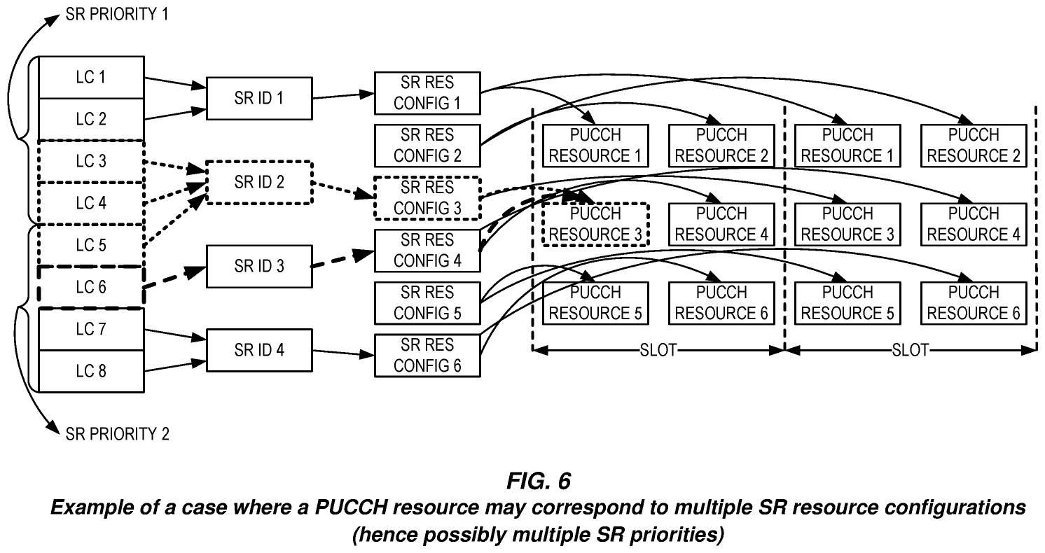

In another example, the PUCCH resource may correspond to multiple SR resource configurations, and then may map to multiple logical channels, and possibly multiple SR priorities. This may happen, for example, when two SR resource configurations uses the same PUCCH resource, but different periodicityAndOffset. In certain SR transmission occasions, two SR resource configurations may use the same PUCCH resource, such as the PUCCH resource 3 illustrated in FIG. 6. In this case both the UE and the gNB may assign the SR in the transmission occasion of the dashed PUCCH resource 3 the highest priority among all the associated logical channels, as well as all the associated SR priorities, e.g. SR priority 1, even if the logical channel that triggered the SR in this transmission occasion is of lower priority (for example, LCH6 with SR priority 2).

2.2 When SR Priority Field is Included in the SR Configuration

Ambiguity may also exist when determining SR priority where SR priority field is included in the SR configuration. For example, in a SR transmission occasion where the PUCCH resource of a given SR transmission occasion maps to multiple SR priorities.

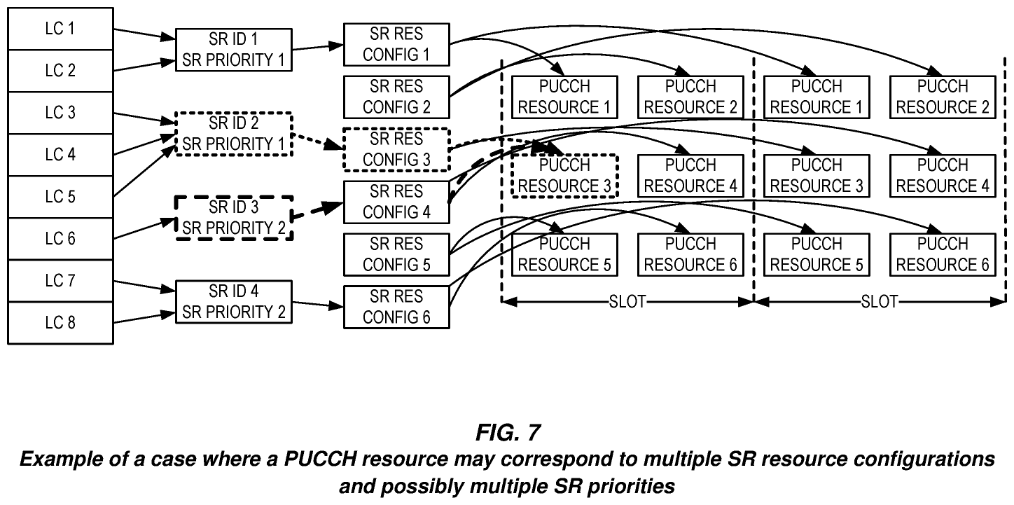

An example is illustrated in FIG. 7. The PUCCH resource may correspond to multiple SR resource configurations, which are associated with multiple SR priorities. In certain SR transmission occasions, two SR resource configurations may use the same PUCCH resource, such as the PUCCH resource 3 illustrated in FIG. 7. In this case both the UE and the gNB may assign the SR in the transmission occasion of the dashed PUCCH resource 3 the highest priority among all the associated SR priorities, e.g. SR priority 1, even if the logical channel that triggered the SR in this transmission occasion is of lower priority (for example, LCH6 with SR priority 2).

3 Example Operation of a Base Station (e.g., gNB) and a UE

FIG. 8 illustrates the operation of a base station 302 (e.g., a gNB) and a UE 312 in accordance with at least some of aspects of the embodiments described above. Optional steps are represented with dashed lines. As illustrated, the base station 302 optionally sends information to the UE 312 that provides a mapping between SR priorities and one or more physical layer properties of the PUCCH used to carry the SR (step 800). Alternatively, the mapping may be predefined, e.g., by standard or derived, e.g., based on one or more parameters, as described above. As discussed above, in some embodiments, the mapping is a mapping between logical channels and respective SR priorities (e.g., each of a number of logical channels is assigned a respective SR priority). In another embodiment, the mapping is a mapping between groups of logical channels and respective SR priorities (e.g., each of a number of groups of logical channels is assigned a respective SR priority). In another embodiment, the mapping is a mapping between SR resource configurations and SR priorities. For example, each of a number of SR resource configurations includes a respective SR priority (e.g., in a respective priority field of the SR resource configuration). In another embodiment, the mapping is a mapping between SR IDs and SR priorities (e.g., each of a number of SR IDs is assigned a respective SR priority or each of a number of groups of SR IDs is assigned a respective SR priority). In some other embodiments, the mapping is a mapping between PUCCH resources and SR priorities (e.g., each of a number of PUCCH resources is assigned a respective SR priority or each of a number of groups of PUCCH resources is assigned a respective SR priority).

The UE 312 transmits a SR for data generated for a particular logical channel on a PUCCH resource in accordance with an associated SR configuration (step 802). An SR priority of the SR is indicated by one or more physical layer properties of the PUCCH resource used to carry the SR, in accordance with the mapping. The base station 302 determines the SR priority of the SR based on the mapping, as described above (step 804). For example, if the mapping is a mapping between logical channels and SR priorities, the base station 302 determines the SR priority of the SR based on the PUCCH resource on which the SR was received, which is mapped to a particular SR configuration(s), which is mapped to one or more logical channels, which are mapped to one or more SR priorities. Any ambiguity in the SR priority is resolved, as described above. For example, if the PUCCH resource maps to two or more logical channels that are mapped to different SR priorities, this ambiguity is resolved in accordance with a predefined or preconfigured rule (e.g., use the lesser of those SR priorities or use the greater of those SR priorities). Optionally, the base station 302 processes the SR in accordance with the determined SR priority (step 806). For example, the base station 302 schedules an uplink transmission for the UE 312 in response to the SR, where the scheduling of this uplink transmission is prioritized relative to other uplink transmissions in accordance with the determined SR priority.

4 Additional Aspects

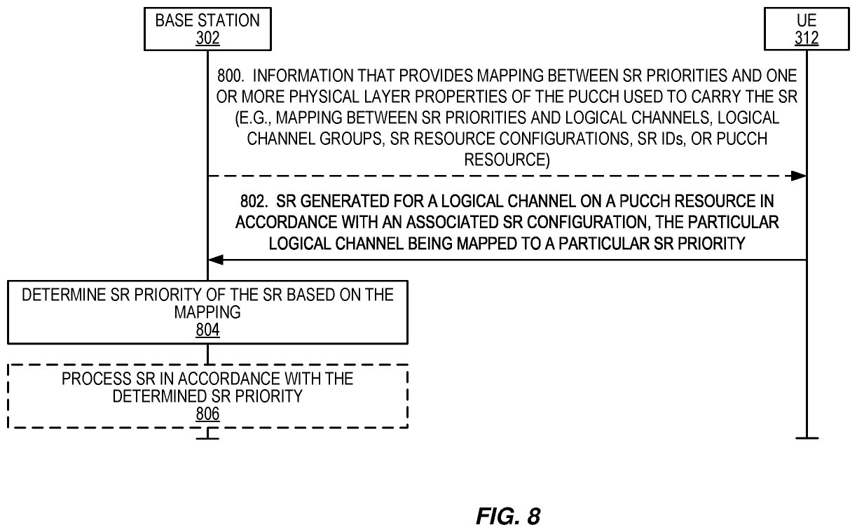

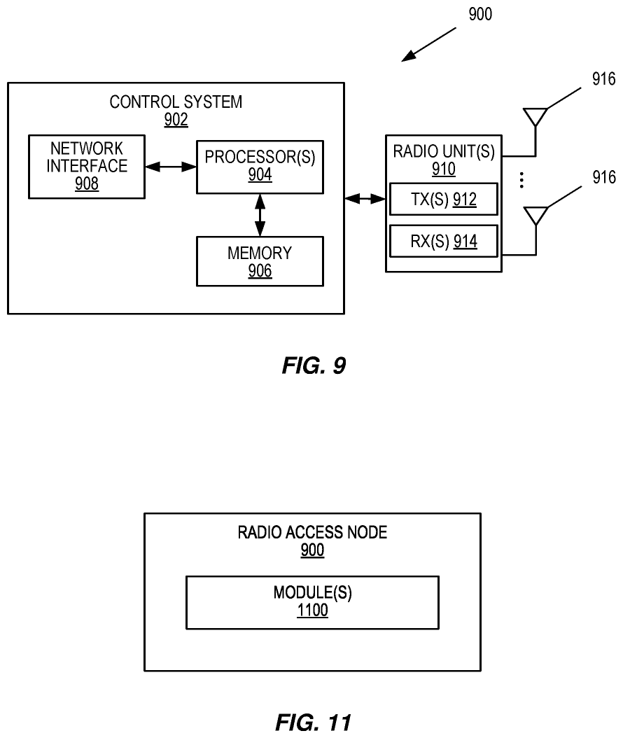

FIG. 9 is a schematic block diagram of a radio access node 900 according to some embodiments of the present disclosure. The radio access node 900 may be, for example, a base station 302 or 306. As illustrated, the radio access node 900 includes a control system 902 that includes one or more processors 904 (e.g., Central Processing Units (CPUs), Application Specific Integrated Circuits (ASICs), Field Programmable Gate Arrays (FPGAs), and/or the like), memory 906, and a network interface 908. The one or more processors 904 are also referred to herein as processing circuitry. In addition, the radio access node 900 includes one or more radio units 910 that each includes one or more transmitters 912 and one or more receivers 914 coupled to one or more antennas 916. The radio units 910 may be referred to or be part of radio interface circuitry. In some embodiments, the radio unit(s) 910 is external to the control system 902 and connected to the control system 902 via, e.g., a wired connection (e.g., an optical cable). However, in some other embodiments, the radio unit(s) 910 and potentially the antenna(s) 916 are integrated together with the control system 902. The one or more processors 904 operate to provide one or more functions of a radio access node 900 as described herein. In some embodiments, the function(s) are implemented in software that is stored, e.g., in the memory 906 and executed by the one or more processors 904.

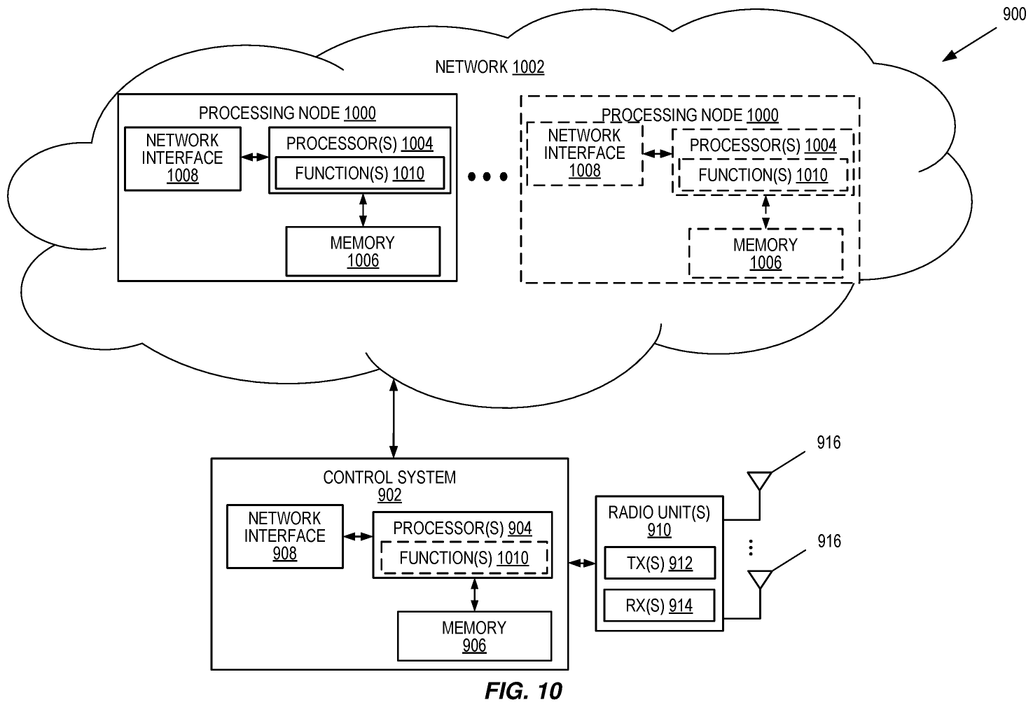

FIG. 10 is a schematic block diagram that illustrates a virtualized embodiment of the radio access node 900 according to some embodiments of the present disclosure. This discussion is equally applicable to other types of network nodes. Further, other types of network nodes may have similar virtualized architectures.

As used herein, a “virtualized” radio access node is an implementation of the radio access node 900 in which at least a portion of the functionality of the radio access node 900 is implemented as a virtual component(s) (e.g., via a virtual machine(s) executing on a physical processing node(s) in a network(s)). As illustrated, in this example, the radio access node 900 includes the control system 902 that includes the one or more processors 904 (e.g., CPUs, ASICs, FPGAs, and/or the like), the memory 906, and the network interface 908 and the one or more radio units 910 that each includes the one or more transmitters 912 and the one or more receivers 914 coupled to the one or more antennas 916, as described above. The control system 902 is connected to the radio unit(s) 910 via, for example, an optical cable or the like. The control system 902 is connected to one or more processing nodes 1000 coupled to or included as part of a network(s) 1002 via the network interface 908. Each processing node 1000 includes one or more processors 1004 (e.g., CPUs, ASICs, FPGAs, and/or the like), memory 1006, and a network interface 1008.

In this example, functions 1010 of the radio access node 900 described herein are implemented at the one or more processing nodes 1000 or distributed across the control system 902 and the one or more processing nodes 1000 in any desired manner In some particular embodiments, some or all of the functions 1010 of the radio access node 900 described herein are implemented as virtual components executed by one or more virtual machines implemented in a virtual environment(s) hosted by the processing node(s) 1000. As will be appreciated by one of ordinary skill in the art, additional signaling or communication between the processing node(s) 1000 and the control system 902 is used in order to carry out at least some of the desired functions 1010. Notably, in some embodiments, the control system 902 may not be included, in which case the radio unit(s) 910 communicate directly with the processing node(s) 1000 via an appropriate network interface(s).

In some embodiments, a computer program including instructions which, when executed by at least one processor, causes the at least one processor to carry out the functionality of radio access node 900 or a node (e.g., a processing node 1000) implementing one or more of the functions 1010 of the radio access node 900 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 11 is a schematic block diagram of the radio access node 900 according to some other embodiments of the present disclosure. The radio access node 900 includes one or more modules 1100, each of which is implemented in software. The module(s) 1100 provide the functionality of the radio access node 900 described herein. This discussion is equally applicable to the processing node 1000 of FIG. 10 where the modules 1100 may be implemented at one of the processing nodes 1000 or distributed across multiple processing nodes 1000 and/or distributed across the processing node(s) 1000 and the control system 902.

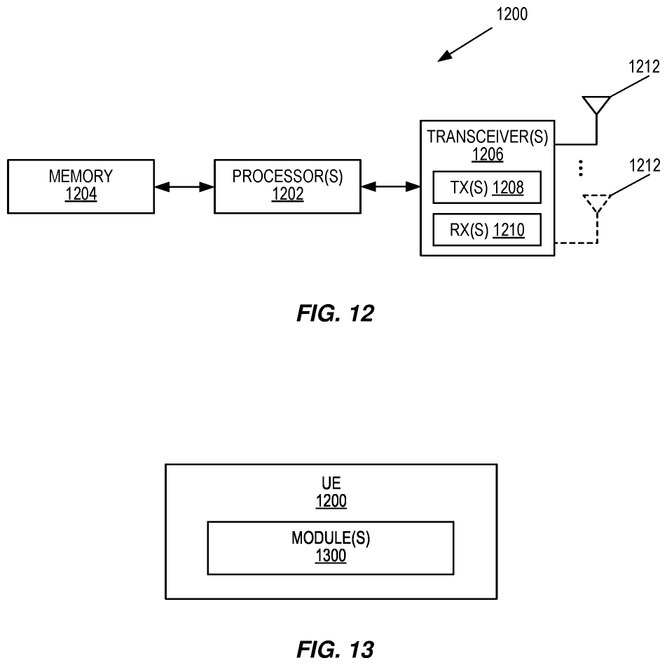

FIG. 12 is a schematic block diagram of a UE 1200 according to some embodiments of the present disclosure. As illustrated, the UE 1200 includes one or more processors 1202 (e.g., CPUs, ASICs, FPGAs, and/or the like), memory 1204, and one or more transceivers 1206 each including one or more transmitters 1208 and one or more receivers 1210 coupled to one or more antennas 1212. The transceiver(s) 1206 includes radio-front end circuitry connected to the antenna(s) 1212 that is configured to condition signals communicated between the antenna(s) 1212 and the processor(s) 1202, as will be appreciated by on of ordinary skill in the art. The processors 1202 are also referred to herein as processing circuitry. The transceivers 1206 are also referred to herein as radio circuitry. In some embodiments, the functionality of the UE 1200 described above may be fully or partially implemented in software that is, e.g., stored in the memory 1204 and executed by the processor(s) 1202. Note that the UE 1200 may include additional components not illustrated in FIG. 12 such as, e.g., one or more user interface components (e.g., an input/output interface including a display, buttons, a touch screen, a microphone, a speaker(s), and/or the like and/or any other components for allowing input of information into the UE 1200 and/or allowing output of information from the UE 1200), a power supply (e.g., a battery and associated power circuitry), etc.

In some embodiments, a computer program including instructions which, when executed by at least one processor, causes the at least one processor to carry out the functionality of the UE 1200 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 13 is a schematic block diagram of the UE 1200 according to some other embodiments of the present disclosure. The UE 1200 includes one or more modules 1300, each of which is implemented in software. The module(s) 1300 provide the functionality of the UE 1200 described herein.

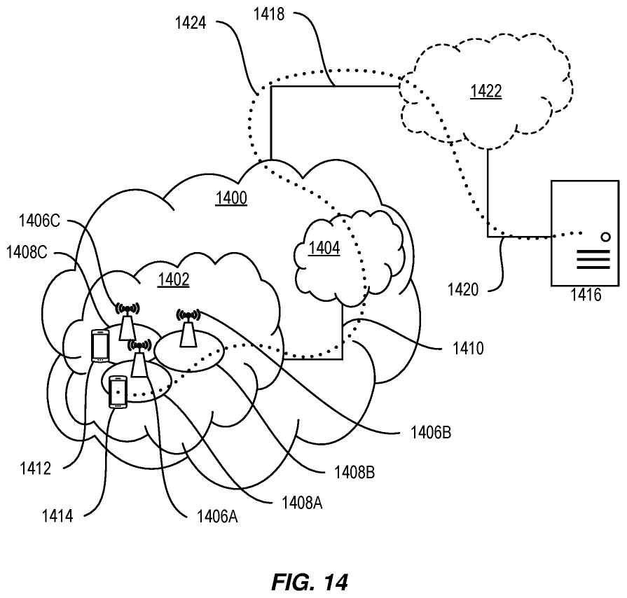

With reference to FIG. 14, in accordance with an embodiment, a communication system includes a telecommunication network 1400, such as a 3GPP-type cellular network, which comprises an access network 1402, such as a RAN, and a core network 1404. The access network 1402 comprises a plurality of base stations 1406A, 1406B, 1406C, such as NBs, eNBs, gNBs, or other types of wireless Access Points (APs), each defining a corresponding coverage area 1408A, 1408B, 1408C. Each base station 1406A, 1406B, 1406C is connectable to the core network 1404 over a wired or wireless connection 1410. A first UE 1412 located in coverage area 1408C is configured to wirelessly connect to, or be paged by, the corresponding base station 1406C. A second UE 1414 in coverage area 1408A is wirelessly connectable to the corresponding base station 1406A. While a plurality of UEs 1412, 1414 are illustrated in this example, the disclosed embodiments are equally applicable to a situation where a sole UE is in the coverage area or where a sole UE is connecting to the corresponding base station 1406.

The telecommunication network 1400 is itself connected to a host computer 1416, which may be embodied in the hardware and/or software of a standalone server, a cloud-implemented server, a distributed server, or as processing resources in a server farm. The host computer 1416 may be under the ownership or control of a service provider, or may be operated by the service provider or on behalf of the service provider. Connections 1418 and 1420 between the telecommunication network 1400 and the host computer 1416 may extend directly from the core network 1404 to the host computer 1416 or may go via an optional intermediate network 1422. The intermediate network 1422 may be one of, or a combination of more than one of, a public, private, or hosted network; the intermediate network 1422, if any, may be a backbone network or the Internet; in particular, the intermediate network 1422 may comprise two or more sub-networks (not shown).

The communication system of FIG. 14 as a whole enables connectivity between the connected UEs 1412, 1414 and the host computer 1416. The connectivity may be described as an Over-the-Top (OTT) connection 1424. The host computer 1416 and the connected UEs 1412, 1414 are configured to communicate data and/or signaling via the OTT connection 1424, using the access network 1402, the core network 1404, any intermediate network 1422, and possible further infrastructure (not shown) as intermediaries. The OTT connection 1424 may be transparent in the sense that the participating communication devices through which the OTT connection 1424 passes are unaware of routing of uplink and downlink communications. For example, the base station 1406 may not or need not be informed about the past routing of an incoming downlink communication with data originating from the host computer 1416 to be forwarded (e.g., handed over) to a connected UE 1412. Similarly, the base station 1406 need not be aware of the future routing of an outgoing uplink communication originating from the UE 1412 towards the host computer 1416.

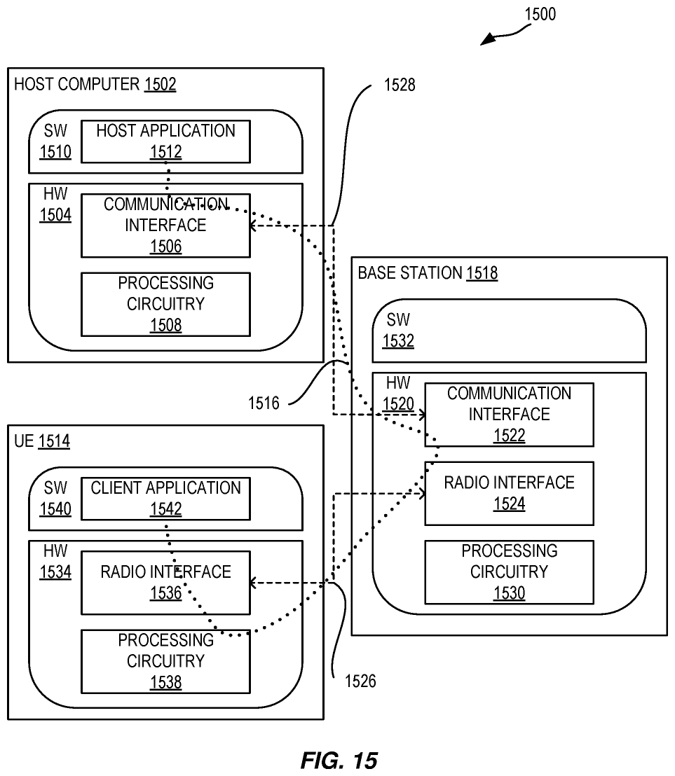

Example implementations, in accordance with an embodiment, of the UE, base station, and host computer discussed in the preceding paragraphs will now be described with reference to FIG. 15. In a communication system 1500, a host computer 1502 comprises hardware 1504 including a communication interface 1506 configured to set up and maintain a wired or wireless connection with an interface of a different communication device of the communication system 1500. The host computer 1502 further comprises processing circuitry 1508, which may have storage and/or processing capabilities. In particular, the processing circuitry 1508 may comprise one or more programmable processors, ASICs, FPGAs, or combinations of these (not shown) adapted to execute instructions. The host computer 1502 further comprises software 1510, which is stored in or accessible by the host computer 1502 and executable by the processing circuitry 1508. The software 1510 includes a host application 1512. The host application 1512 may be operable to provide a service to a remote user, such as a UE 1514 connecting via an OTT connection 1516 terminating at the UE 1514 and the host computer 1502. In providing the service to the remote user, the host application 1512 may provide user data which is transmitted using the OTT connection 1516.

The communication system 1500 further includes a base station 1518 provided in a telecommunication system and comprising hardware 1520 enabling it to communicate with the host computer 1502 and with the UE 1514. The hardware 1520 may include a communication interface 1522 for setting up and maintaining a wired or wireless connection with an interface of a different communication device of the communication system 1500, as well as a radio interface 1524 for setting up and maintaining at least a wireless connection 1526 with the UE 1514 located in a coverage area (not shown in FIG. 15) served by the base station 1518. The communication interface 1522 may be configured to facilitate a connection 1528 to the host computer 1502. The connection 1528 may be direct or it may pass through a core network (not shown in FIG. 15) of the telecommunication system and/or through one or more intermediate networks outside the telecommunication system. In the embodiment shown, the hardware 1520 of the base station 1518 further includes processing circuitry 1530, which may comprise one or more programmable processors, ASICs, FPGAs, or combinations of these (not shown) adapted to execute instructions. The base station 1518 further has software 1532 stored internally or accessible via an external connection.

The communication system 1500 further includes the UE 1514 already referred to. The UE's 1514 hardware 1534 may include a radio interface 1536 configured to set up and maintain a wireless connection 1526 with a base station serving a coverage area in which the UE 1514 is currently located. The hardware 1534 of the UE 1514 further includes processing circuitry 1538, which may comprise one or more programmable processors, ASICs, FPGAs, or combinations of these (not shown) adapted to execute instructions. The UE 1514 further comprises software 1540, which is stored in or accessible by the UE 1514 and executable by the processing circuitry 1538. The software 1540 includes a client application 1542. The client application 1542 may be operable to provide a service to a human or non-human user via the UE 1514, with the support of the host computer 1502. In the host computer 1502, the executing host application 1512 may communicate with the executing client application 1542 via the OTT connection 1516 terminating at the UE 1514 and the host computer 1502. In providing the service to the user, the client application 1542 may receive request data from the host application 1512 and provide user data in response to the request data. The OTT connection 1516 may transfer both the request data and the user data. The client application 1542 may interact with the user to generate the user data that it provides.

It is noted that the host computer 1502, the base station 1518, and the UE 1514 illustrated in FIG. 15 may be similar or identical to the host computer 1416, one of the base stations 1406A, 1406B, 1406C, and one of the UEs 1412, 1414 of FIG. 14, respectively. This is to say, the inner workings of these entities may be as shown in FIG. 15 and independently, the surrounding network topology may be that of FIG. 14.

In FIG. 15, the OTT connection 1516 has been drawn abstractly to illustrate the communication between the host computer 1502 and the UE 1514 via the base station 1518 without explicit reference to any intermediary devices and the precise routing of messages via these devices. The network infrastructure may determine the routing, which may be configured to hide from the UE 1514 or from the service provider operating the host computer 1502, or both. While the OTT connection 1516 is active, the network infrastructure may further take decisions by which it dynamically changes the routing (e.g., on the basis of load balancing consideration or reconfiguration of the network).

The wireless connection 1526 between the UE 1514 and the base station 1518 is in accordance with the teachings of the embodiments described throughout this disclosure. One or more of the various embodiments improve the performance of OTT services provided to the UE 1514 using the OTT connection 1516, in which the wireless connection 1526 forms the last segment. More precisely, the teachings of these embodiments may improve, e.g., latency and thereby provide benefits such as, e.g., reduced user waiting time and better responsiveness.

A measurement procedure may be provided for the purpose of monitoring data rate, latency, and other factors on which the one or more embodiments improve. There may further be an optional network functionality for reconfiguring the OTT connection 1516 between the host computer 1502 and the UE 1514, in response to variations in the measurement results. The measurement procedure and/or the network functionality for reconfiguring the OTT connection 1516 may be implemented in the software 1510 and the hardware 1504 of the host computer 1502 or in the software 1540 and the hardware 1534 of the UE 1514, or both. In some embodiments, sensors (not shown) may be deployed in or in association with communication devices through which the OTT connection 1516 passes; the sensors may participate in the measurement procedure by supplying values of the monitored quantities exemplified above, or supplying values of other physical quantities from which the software 1510, 1540 may compute or estimate the monitored quantities. The reconfiguring of the OTT connection 1516 may include message format, retransmission settings, preferred routing, etc.; the reconfiguring need not affect the base station 1518, and it may be unknown or imperceptible to the base station 1518. Such procedures and functionalities may be known and practiced in the art. In certain embodiments, measurements may involve proprietary UE signaling facilitating the host computer 1502's measurements of throughput, propagation times, latency, and the like. The measurements may be implemented in that the software 1510 and 1540 causes messages to be transmitted, in particular empty or ‘dummy’ messages, using the OTT connection 1516 while it monitors propagation times, errors, etc.

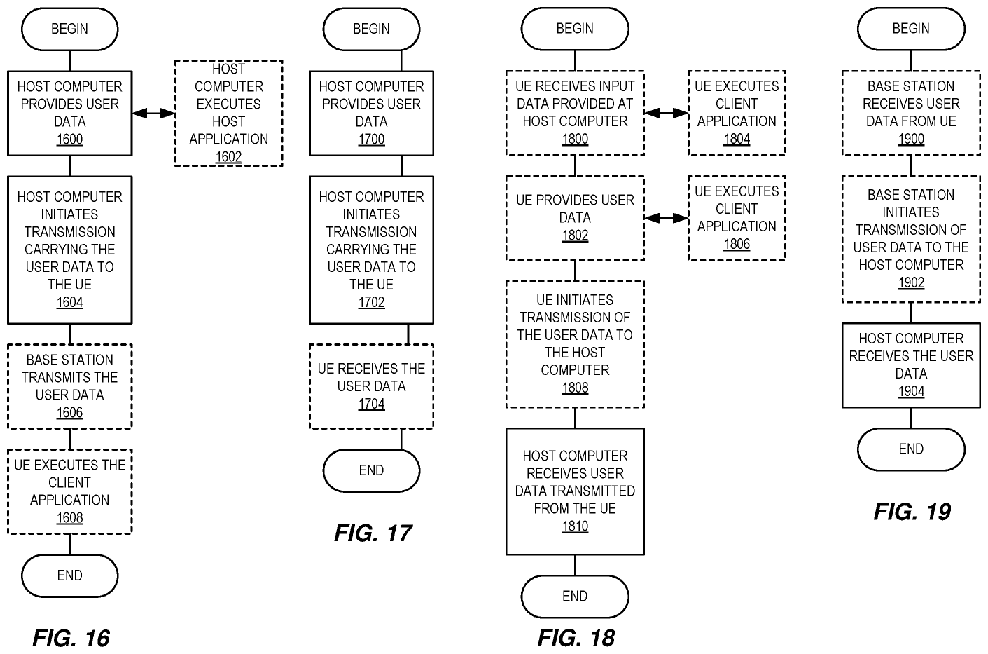

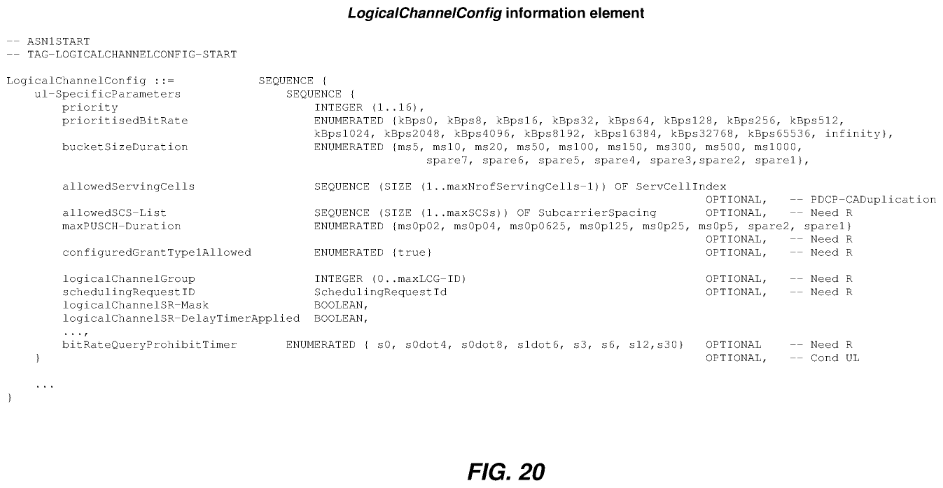

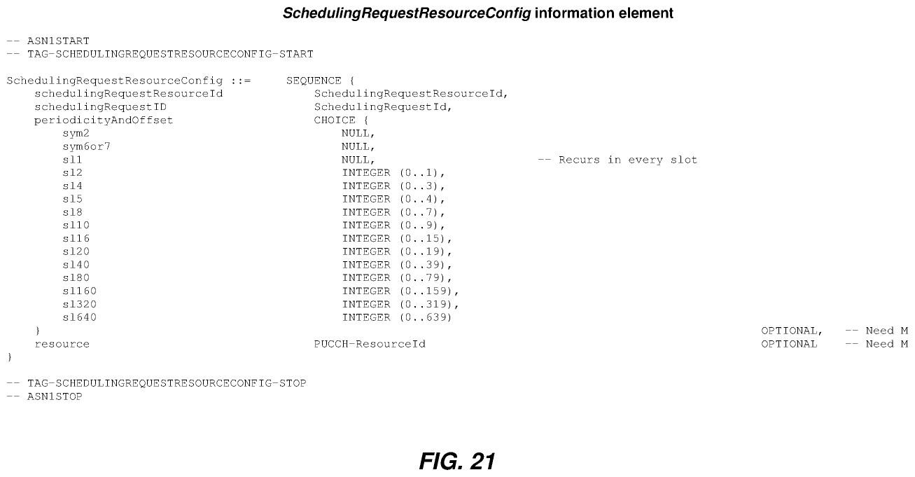

FIG. 16 is a flowchart illustrating a method implemented in a communication system, in accordance with one embodiment. The communication system includes a host computer, a base station, and a UE which may be those described with reference to FIGS. 14 and 15. For simplicity of the present disclosure, only drawing references to FIG. 16 will be included in this section. In step 1600, the host computer provides user data. In sub-step 1602 (which may be optional) of step 1600, the host computer provides the user data by executing a host application. In step 1604, the host computer initiates a transmission carrying the user data to the UE. In step 1606 (which may be optional), the base station transmits to the UE the user data which was carried in the transmission that the host computer initiated, in accordance with the teachings of the embodiments described throughout this disclosure. In step 1608 (which may also be optional), the UE executes a client application associated with the host application executed by the host computer.

FIG. 17 is a flowchart illustrating a method implemented in a communication system, in accordance with one embodiment. The communication system includes a host computer, a base station, and a UE which may be those described with reference to FIGS. 14 and 15. For simplicity of the present disclosure, only drawing references to FIG. 17 will be included in this section. In step 1700 of the method, the host computer provides user data. In an optional sub-step (not shown) the host computer provides the user data by executing a host application. In step 1702, the host computer initiates a transmission carrying the user data to the UE. The transmission may pass via the base station, in accordance with the teachings of the embodiments described throughout this disclosure. In step 1704 (which may be optional), the UE receives the user data carried in the transmission.

FIG. 18 is a flowchart illustrating a method implemented in a communication system, in accordance with one embodiment. The communication system includes a host computer, a base station, and a UE which may be those described with reference to FIGS. 14 and 15. For simplicity of the present disclosure, only drawing references to FIG. 18 will be included in this section. In step 1800 (which may be optional), the UE receives input data provided by the host computer. Additionally or alternatively, in step 1802, the UE provides user data. In sub-step 1804 (which may be optional) of step 1800, the UE provides the user data by executing a client application. In sub-step 1806 (which may be optional) of step 1802, the UE executes a client application which provides the user data in reaction to the received input data provided by the host computer. In providing the user data, the executed client application may further consider user input received from the user. Regardless of the specific manner in which the user data was provided, the UE initiates, in sub-step 1808 (which may be optional), transmission of the user data to the host computer. In step 1810 of the method, the host computer receives the user data transmitted from the UE, in accordance with the teachings of the embodiments described throughout this disclosure.

FIG. 19 is a flowchart illustrating a method implemented in a communication system, in accordance with one embodiment. The communication system includes a host computer, a base station, and a UE which may be those described with reference to FIGS. 14 and 15. For simplicity of the present disclosure, only drawing references to FIG. 19 will be included in this section. In step 1900 (which may be optional), in accordance with the teachings of the embodiments described throughout this disclosure, the base station receives user data from the UE. In step 1902 (which may be optional), the base station initiates transmission of the received user data to the host computer. In step 1904 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Some example embodiments of the present disclosure are as follows:

### Group A Embodiments

Embodiment 1: A method performed by a wireless device (312) for prioritized scheduling request, SR, transmission, the method comprising: transmitting (802), to a base station (302), a SR for data generated on a particular logical channel on a physical uplink control channel, PUCCH, resource in accordance with an associated SR configuration; wherein a SR priority of the SR is indicated by one or more physical layer properties of the PUCCH resource, in accordance with a mapping between the SR priority and the one or more physical layer properties of the PUCCH.

Embodiment 2: The method of embodiment 1 wherein the mapping is a mapping between the SR priority and the particular logical channel.

Embodiment 3: The method of embodiment 1 wherein the mapping is a mapping between the SR priority and a group of logical channels comprising the particular logical channel.

Embodiment 4: The method of embodiment 1 wherein the mapping is a mapping between the SR priority and the associated SR resource configuration.

Embodiment 5: The method of embodiment 4 further comprising receiving (800), from the base station, the SR resource configuration, wherein the SR resource configuration comprises an indication of the SR priority.

Embodiment 6: The method of embodiment 1 wherein the mapping is a mapping between the SR priority and an SR ID mapped to the associated SR resource configuration.

Embodiment 7: The method of embodiment 1 wherein the mapping is a mapping between the SR priority and the PUCCH resource.

Embodiment 8: The method of embodiment 1 wherein the mapping is a mapping between the SR priority and a group of PUCCH resources comprising the PUCCH resource.

Embodiment 9: The method of any one of embodiments 1-3 and 6-8 further comprising receiving (800), from the base station, information that provides the mapping between the SR priority and the one or more physical layer properties of the PUCCH resource.

Embodiment 10: The method of claim 9 wherein receiving the information comprises receiving the information via RRC signaling.

Embodiment 11: The method of any one of embodiments 1-3 and 6-8 further comprising deriving the mapping between the SR priority and the one or more physical layer properties of the PUCCH resource.

Embodiment 12: The method of any of the previous embodiments, further comprising: providing user data; and forwarding the user data to a host computer via a transmission to the base station, the transmission being scheduled in response to the SR.

### Group B Embodiments

Embodiment 13: A method performed by a base station for scheduling request, SR, prioritization, the method comprising: receiving (802), from a User Equipment, UE, (302), a SR for data generated on a particular logical channel on a physical uplink control channel, PUCCH, resource in accordance with an associated SR configuration; and determining (804) a SR priority of the SR based on a mapping between the SR priority and one or more physical layer properties of the PUCCH.

Embodiment 14: The method of embodiment 13 wherein the mapping is a mapping between the SR priority and the particular logical channel.

Embodiment 15: The method of embodiment 13 wherein the mapping is a mapping between the SR priority and a group of logical channels comprising the particular logical channel.

Embodiment 16: The method of embodiment 13 wherein the mapping is a mapping between the SR priority and the associated SR resource configuration.

Embodiment 17: The method of embodiment 16 further comprising transmitting (800), to the UE, the SR resource configuration, wherein the SR resource configuration comprises an indication of the SR priority.

Embodiment 18: The method of embodiment 13 wherein the mapping is a mapping between the SR priority and an SR ID mapped to the associated SR resource configuration.

Embodiment 19: The method of embodiment 13 wherein the mapping is a mapping between the SR priority and the PUCCH resource.

Embodiment 20: The method of embodiment 13 wherein the mapping is a mapping between the SR priority and a group of PUCCH resources comprising the PUCCH resource.

Embodiment 21: The method of any one of embodiments 13-15 and 18-20 further comprising transmitting (800), to the UE, information that provides the mapping between the SR priority and the one or more physical layer properties of the PUCCH resource.

Embodiment 22: The method of claim 21 wherein transmitting the information comprises transmitting the information via RRC signaling.

Embodiment 23: The method of any one of embodiments 13-15 and 18-20 further comprising deriving the mapping between the SR priority and the one or more physical layer properties of the PUCCH resource.

Embodiment 24: The method of any one of embodiments 13 to 23 further comprising processing (806) the SR in accordance with the determined SR priority.

Embodiment 25: The method of any of the previous embodiments, further comprising: obtaining user data; and forwarding the user data to a host computer or the UE.

### Group C Embodiments

Embodiment 26: A wireless device for prioritized scheduling request, SR, transmission, the wireless device comprising: processing circuitry configured to perform any of the steps of any of the Group A embodiments; and power supply circuitry configured to supply power to the wireless device.

Embodiment 27: A base station for scheduling request, SR, prioritization, the base station comprising: processing circuitry configured to perform any of the steps of any of the Group B embodiments; and power supply circuitry configured to supply power to the base station.

Embodiment 28: A User Equipment, UE, for prioritized scheduling request, SR, transmission, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 29: A communication system including a host computer comprising:

processing circuitry configured to provide user data; and a communication interface configured to forward the user data to a cellular network for transmission to a User Equipment, UE; wherein the cellular network comprises a base station having a radio interface and processing circuitry, the base station's processing circuitry configured to perform any of the steps of any of the Group B embodiments.

Embodiment 30: The communication system of the previous embodiment further including the base station.

Embodiment 31: The communication system of the previous 2 embodiments, further including the UE, wherein the UE is configured to communicate with the base station.

Embodiment 32: The communication system of the previous 3 embodiments, wherein: the processing circuitry of the host computer is configured to execute a host application, thereby providing the user data; and the UE comprises processing circuitry configured to execute a client application associated with the host application.

Embodiment 33: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the base station performs any of the steps of any of the Group B embodiments.

Embodiment 34: The method of the previous embodiment, further comprising, at the base station, transmitting the user data.

Embodiment 35: The method of the previous 2 embodiments, wherein the user data is provided at the host computer by executing a host application, the method further comprising, at the UE, executing a client application associated with the host application.

Embodiment 36: A User Equipment, UE, configured to communicate with a base station, the UE comprising a radio interface and processing circuitry configured to perform the method of the previous 3 embodiments.

Embodiment 37: A communication system including a host computer comprising: processing circuitry configured to provide user data; and a communication interface configured to forward user data to a cellular network for transmission to a User Equipment, UE; wherein the UE comprises a radio interface and processing circuitry, the UE's components configured to perform any of the steps of any of the Group A embodiments.

Embodiment 38: The communication system of the previous embodiment, wherein the cellular network further includes a base station configured to communicate with the UE.

Embodiment 39: The communication system of the previous 2 embodiments, wherein: the processing circuitry of the host computer is configured to execute a host application, thereby providing the user data; and the UE's processing circuitry is configured to execute a client application associated with the host application.

Embodiment 40: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the UE performs any of the steps of any of the Group A embodiments.

Embodiment 41: The method of the previous embodiment, further comprising at the

UE, receiving the user data from the base station.

Embodiment 42: A communication system including a host computer comprising: Communication interface configured to receive user data originating from a transmission from a User Equipment, UE, to a base station; wherein the UE comprises a radio interface and processing circuitry, the UE's processing circuitry configured to perform any of the steps of any of the Group A embodiments.

Embodiment 43: The communication system of the previous embodiment, further including the UE.

Embodiment 44: The communication system of the previous 2 embodiments, further including the base station, wherein the base station comprises a radio interface configured to communicate with the UE and a communication interface configured to forward to the host computer the user data carried by a transmission from the UE to the base station.

Embodiment 45: The communication system of the previous 3 embodiments, wherein: the processing circuitry of the host computer is configured to execute a host application; and the UE's processing circuitry is configured to execute a client application associated with the host application, thereby providing the user data.

Embodiment 46: The communication system of the previous 4 embodiments, wherein: the processing circuitry of the host computer is configured to execute a host application, thereby providing request data; and the UE's processing circuitry is configured to execute a client application associated with the host application, thereby providing the user data in response to the request data.

Embodiment 47: A method implemented in a communication system including a host computer, a base station, and a User Equipment, UE, the method comprising: at the host computer, receiving user data transmitted to the base station from the UE, wherein the UE performs any of the steps of any of the Group A embodiments.

Embodiment 48: The method of the previous embodiment, further comprising, at the UE, providing the user data to the base station.

Embodiment 49: The method of the previous 2 embodiments, further comprising: at the UE, executing a client application, thereby providing the user data to be transmitted; and at the host computer, executing a host application associated with the client application.

Embodiment 50: The method of the previous 3 embodiments, further comprising: at the UE, executing a client application; and at the UE, receiving input data to the client application, the input data being provided at the host computer by executing a host application associated with the client application; wherein the user data to be transmitted is provided by the client application in response to the input data.

Embodiment 51: A communication system including a host computer comprising a communication interface configured to receive user data originating from a transmission from a User Equipment, UE, to a base station, wherein the base station comprises a radio interface and processing circuitry, the base station's processing circuitry configured to perform any of the steps of any of the Group B embodiments.

Embodiment 52: The communication system of the previous embodiment further including the base station.

Embodiment 53: The communication system of the previous 2 embodiments, further including the UE, wherein the UE is configured to communicate with the base station.

Embodiment 54: The communication system of the previous 3 embodiments, wherein: the processing circuitry of the host computer is configured to execute a host application; and the UE is configured to execute a client application associated with the host application, thereby providing the user data to be received by the host computer.

Embodiment 55: A method implemented in a communication system including a host computer, a base station, and a User Equipment, UE, the method comprising: at the host computer, receiving, from the base station, user data originating from a transmission which the base station has received from the UE, wherein the UE performs any of the steps of any of the Group A embodiments.

Embodiment 56: The method of the previous embodiment, further comprising at the base station, receiving the user data from the UE.

Embodiment 57: The method of the previous 2 embodiments, further comprising at the base station, initiating a transmission of the received user data to the host computer.

At least some of the following abbreviations may be used in this disclosure. If there is an inconsistency between abbreviations, preference should be given to how it is used above. If listed multiple times below, the first listing should be preferred over any subsequent listing(s).

3GPP Third Generation Partnership Project

5G Fifth Generation

5GC Fifth Generation Core

5GS Fifth Generation System

AF Application Function

AMF Access and Mobility Function

AN Access Network

AP Access Point

ASIC Application Specific Integrated Circuit

AUSF Authentication Server Function

CPU Central Processing Unit

DN Data Network

DSP Digital Signal Processor

eNB Enhanced or Evolved Node B

EPS Evolved Packet System

E-UTRA Evolved Universal Terrestrial Radio Access

FPGA Field Programmable Gate Array

gNB New Radio Base Station

gNB-DU New Radio Base Station Distributed Unit

HSS Home Subscriber Server

IoT Internet of Things

IP Internet Protocol

LTE Long Term Evolution

MME Mobility Management Entity

MTC Machine Type Communication

NEF Network Exposure Function

NF Network Function

NR New Radio

NRF Network Function Repository Function

NSSF Network Slice Selection Function

OTT Over-the-Top

PC Personal Computer

PCF Policy Control Function

P-GW Packet Data Network Gateway

QoS Quality of Service

RAM Random Access Memory

RAN Radio Access Network

ROM Read Only Memory

RRH Remote Radio Head

RTT Round Trip Time

SCEF Service Capability Exposure Function

SMF Session Management Function

UDM Unified Data Management

UE User Equipment

UPF User Plane Function

Those skilled in the art will recognize improvements and modifications to the embodiments of the present disclosure. All such improvements and modifications are considered within the scope of the concepts disclosed herein.

1. (canceled)

2. A method performed by a wireless device for prioritized scheduling request transmission, the method comprising:
transmitting, to a base station, a scheduling request for data generated on a particular logical channel on a physical uplink control channel (PUCCH) resource in accordance with an associated scheduling request configuration;
wherein a scheduling request priority of the scheduling request is indicated by one or more physical layer properties of the PUCCH resource, in accordance with a mapping between the one or more physical layer properties of the PUCCH and the scheduling request priority.

3. The method of claim 2 wherein the mapping is a mapping between the associated scheduling request resource configuration and the scheduling request priority.

4. The method of claim 3 further comprising receiving the associated scheduling request resource configuration from the base station, wherein the associated scheduling request resource configuration comprises an indication of the scheduling request priority.

5. The method of claim 2 wherein the mapping is a mapping between the particular logical channel and the scheduling request priority.

6. The method of claim 2 wherein the mapping is a mapping between a group of logical channels comprising the particular logical channel and the scheduling request priority.

7. The method of claim 2 wherein the mapping is based on one or more configurable thresholds for one or more properties of the particular logical channel.

8. The method of claim 2 wherein the mapping is a mapping between an scheduling request identity mapped to the associated scheduling request resource configuration and the scheduling request priority.

9. The method of claim 2 wherein the mapping is a mapping between a group of scheduling request identities comprising an scheduling request identity mapped to the associated scheduling request resource configuration and the scheduling request priority.

10. The method of claim 2 wherein the mapping is a mapping between the PUCCH resource and the scheduling request priority.

11. The method of claim 2 wherein the associated scheduling request resource configuration comprises a field that indicates the PUCCH resource, and the scheduling request priority is determined by a priority associated with the PUCCH resource.

12. The method of claim 2 further comprising receiving, from the base station, information that provides the mapping between the one or more physical layer properties of the PUCCH resource and the scheduling request priority.

13. The method of claim 12 wherein receiving the information comprises receiving the information via Radio Resource Control (RRC) signaling.

14-15. (canceled)

16. A wireless device for prioritized scheduling request transmission, the wireless device comprising:
one or more transmitters; and
processing circuitry associated with the one or more transmitters, the processing circuitry configured to cause the wireless device to transmit, to a base station, a scheduling request for data generated on a particular logical channel on a physical uplink control channel (PUCCH) resource in accordance with an associated scheduling request configuration;
wherein a scheduling request priority of the scheduling request is indicated by one or more physical layer properties of the PUCCH resource, in accordance with a mapping between the one or more physical layer properties of the PUCCH and the scheduling request priority.

17. A method performed by a base station for scheduling request prioritization, the method comprising:
receiving, from a wireless device, a scheduling request for data generated on a particular logical channel on a physical uplink control channel (PUCCH) resource in accordance with an associated scheduling request resource configuration; and
determining a scheduling request priority of the scheduling request based on a mapping between one or more physical layer properties of the PUCCH and the scheduling request priority.

18. The method of claim 17 wherein the mapping is a mapping between the associated scheduling request resource configuration and the scheduling request priority.

19. The method of claim 18 further comprising transmitting, to the wireless device, the scheduling request resource configuration, wherein the scheduling request resource configuration comprises an indication of the scheduling request priority.

20. The method of claim 17 wherein the mapping is a mapping between the particular logical channel and the scheduling request priority.

21. The method of claim 17 wherein the mapping is a mapping between a group of logical channels comprising the particular logical channel and the scheduling request priority.

22. The method of claim 17 wherein the mapping is based on one or more configurable thresholds for one or more properties of the particular logical channel.

23. The method of claim 17 wherein the mapping is a mapping between an scheduling request identity mapped to the associated scheduling request resource configuration and the scheduling request priority.

24. The method of claim 17 wherein the mapping is a mapping between a group of scheduling request identities comprising an scheduling request identity mapped to the associated scheduling request resource configuration and the scheduling request priority.

25. The method of claim 17 wherein the mapping is a mapping between the PUCCH resource and the scheduling request priority.

26. The method of claim 17 further comprising transmitting, to the wireless device, information that provides the mapping between the one or more physical layer properties of the PUCCH resource and the scheduling request priority.

27. The method of claim 26 wherein transmitting the information comprises transmitting the information via Radio Resource Control (RRC) signaling.

28. The method of claim 17 further comprising processing the scheduling request in accordance with the determined scheduling request priority.

29. The method of claim 17 wherein the mapping maps the one or more physical layer properties of the PUCCH resource to two or more scheduling request priorities, and determining the scheduling request priority of the scheduling request based on the mapping comprises selecting one of the two or more scheduling request priorities as the scheduling request priority of the scheduling request.

30. The method of claim 29 wherein selecting one of the two or more scheduling request priorities as the scheduling request priority of the scheduling request comprises selecting a highest scheduling request priority from among the two or more scheduling request priorities as the scheduling request priority of the SR.

31. The method of claim 29 wherein selecting one of the two or more scheduling request priorities as the scheduling request priority of the scheduling request comprises selecting a lowest scheduling request priority from among the two or more scheduling request priorities as the scheduling request priority of the SR.

32-33. (canceled)

34. A base station for scheduling request, SR, prioritization, the base station comprising:
processing circuitry configured to cause the base station to:
receive, from a wireless device, a scheduling request for data generated on a particular logical channel on a physical uplink control channel (PUCCH) resource in accordance with an associated scheduling request configuration; and
determine a scheduling request priority of the scheduling request based on a mapping between one or more physical layer properties of the PUCCH and the scheduling request priority.
